(19) United States
(12) Patent Application Publication
(10) Pub. No.: US 2025/0373487 A1
(43) Pub. Date: Dec. 4, 2025

(54) TRANSACTION FAILURE CAUSE DETECTION AND ALERTING FOR WIRELESS NETWORK TRANSACTIONS

(71) Applicant: AT&T Intellectual Property I, L.P., Atlanta, GA (US)

(72) Inventors: Willa Ehrlich, Highland Park, NJ (US); Li-Chuan Sun, Holmdel, NJ (US); Mark Stockert, San Antonio, TX (US); Jerry Robinson, Middletown, NJ (US); Sean Simon, Lynnwood, WA (US)

(21) Appl. No.: 18/679,429

(22) Filed: May 30, 2024

(51) Int. Cl. H04L 41/0677; H04L 41/0654

(52) U.S. Cl. CPC H04L 41/0677; H04L 41/0654

(57) ABSTRACT

A processing system may obtain a plurality of sequences of network function transaction events, each sequence comprising a plurality of network function transaction events in a communication network. The processing system may next apply the plurality of sequences as inputs to a sequential rule mining module implemented by the processing system to obtain a first rule set comprising at least a first rule, where the first rule indicates that a consequent network function transaction event follows an antecedent comprising one or more prior network function transaction events, and may apply the plurality of sequences as inputs to a generative model to obtain a second rule set. The processing system may then identify that the first rule is contained in the first and second rule sets, and may add the first rule to a set of active rules for generating alerts in the communication network, in response.

### BACKGROUND

The present disclosure relates generally to wireless communication networks, and more particularly to methods, non-transitory computer-readable media, and apparatuses for adding a rule to a set of active rules for generating alerts in a communication network when the rule is contained in both a first rule set obtained via a sequential rule mining and a second rule set obtained via a generative model, and to methods, non-transitory computer-readable media, and apparatuses for applying a plurality of sequences as inputs to a generative model to generate a rule set comprising at least one rule indicating a probability that a consequent network function transaction event follows an antecedent comprising one or more prior network function transaction events.

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. 5G is intended to deliver superior high speed and performance. However, during initial deployments, 5G may potentially suffer from limited coverage areas, higher costs of deployment, slow rollout, and more costly initial subscription plans.

### SUMMARY

In one example, the present disclosure discloses a method, computer-readable medium, and apparatus for adding a rule to a set of active rules for generating alerts in a communication network when the rule is contained in both a first rule set obtained via a sequential rule mining and a second rule set obtained via a generative model. For example, a processing system including at least one processor may obtain a plurality of sequences of network function transaction events, each of the plurality of sequences comprising a plurality of network function transaction events in a communication network. The processing system may next apply the plurality of sequences as inputs to a sequential rule mining module implemented by the processing system to obtain a first rule set comprising at least a first rule, where the first rule indicates that a consequent network function transaction event follows an antecedent comprising one or more prior network function transaction events. In addition, the processing system may apply the plurality of sequences as inputs to a generative model to obtain a second rule set. The processing system may then identify that the first rule is contained in the first rule set and the second rule set, and may add the first rule to a set of active rules for generating alerts in the communication network, in response to identifying that the first rule is contained in the first rule set and the second rule set.

In addition, in one example, the present disclosure discloses a method, computer-readable medium, and apparatus for applying a plurality of sequences as inputs to a generative model to generate a rule set comprising at least one rule indicating a probability that a consequent network function transaction event follows an antecedent comprising one or more prior network function transaction events. For example, a processing system including at least one processor may obtain a plurality of sequences of network function transaction events, each of the plurality of sequences comprising a plurality of network function transaction events. The processing system may next apply the plurality of sequences as inputs to a generative model to generate a rule set comprising at least one rule indicating a probability that a consequent network function transaction event follows an antecedent comprising one or more prior network function transaction events. The processing system may then add the at least one rule to a set of active rules for generating alerts in the communication network.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an example sequence of network function transaction events, e.g., failure event notifications;

FIG. 3 illustrates example sequences of network function transaction events for several mobility network transactions involving various network functions (NFs);

FIG. 4 illustrates an example set of sequential rules that may be derived from sequential rule mining;

FIG. 5 illustrates an example method of processing a prompt via a generative model to generate an interpretation of at least one aspect of a rule set obtained via a sequential rule mining module, the rule set including at least one rule indicating a probability that a consequent network function transaction event follows an antecedent comprising one or more prior network function transaction events;

FIG. 6 illustrates an example process for retrieval augmented generation, in accordance with the present disclosure;

FIG. 7 illustrates an example prompt for a generative model, in accordance with the present disclosure;

FIG. 8 illustrates an example response (e.g., which may be generated via a generative model in response to the prompt of FIG. 7);

FIG. 9 illustrates an additional prompt and response of a generative model, in accordance with the present disclosure;

FIG. 10 illustrates an additional example of the present disclosure in which one or more sequential rules may be extracted via a generative model;

FIG. 11 illustrates still another example of the present disclosure in which one or more rules may be extracted via a generative model;

FIG. 12 illustrates an example prompt and response containing rules identified via a generative model, in accordance with the present disclosure;

FIG. 13 illustrates still another example prompt and response containing rules identified via a generative model, in accordance with the present disclosure;

FIG. 14 illustrates a flowchart of an example method for adding a rule to a set of active rules for generating alerts in a communication network when the rule is contained in both a first rule set obtained via a sequential rule mining and a second rule set obtained via a generative model;

FIG. 15 illustrates a flowchart of an example method for applying a plurality of sequences as inputs to a generative model to generate a rule set comprising at least one rule indicating a probability that a consequent network function transaction event follows an antecedent comprising one or more prior network function transaction events; and

FIG. 16 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for adding a rule to a set of active rules for generating alerts in a communication network when the rule is contained in both a first rule set obtained via a sequential rule mining and a second rule set obtained via a generative model, and methods, computer-readable media, and apparatuses for applying a plurality of sequences as inputs to a generative model to generate a rule set comprising at least one rule indicating a probability that a consequent network function transaction event follows an antecedent comprising one or more prior network function transaction events. In particular, in modern mobility networks, multiple virtual/containerized/physical network functions (NFs) participate in servicing an endpoint device-initiated transaction. In one example, when a transaction fails, a “trail” of time-stamped failure event messages may be generated. These failure event messages may specify the network function (NF) initiating a procedure or message, the NF that is the recipient of the request, the failure reason in the message returned by the recipient NF and a timestamp of the (failure) event. Since this “trail” of failure events can be ordered by time, these failure events may comprise a sequence or list of ordered items.

Examples of the present disclosure may include several aspects. For instance, the present disclosure may first ingest data from a database of N sequences, each sequence representing an ordered list of network function (NF) transaction events (e.g., failures/failure event messages). Examples of the present disclosure may then apply sequential rule mining to derive sequential rules, e.g., of the form P⇒Q, based on a confidence or probability (in one example, a probability of 1.0). These rules may be referred to as sequential rule mining (SRM)-generated sequential rules. Next, examples of the present disclosure may apply a generative model (e.g., a generative artificial intelligence (AI) and/or machine learning (ML)-based model) to generate an automated interpretation of the SRM-generated sequential rules. In one example, the present disclosure may further apply a generative model (e.g., the same or different as the generative model used for interpretation) to derive a second set of sequential rules, which may be referred to as generative AI (GenAI)-derived sequential rules, based on the same N sequences. In one example, an evaluation procedure may be applied to select a final set of sequential rules. The final set of sequential rules, together with the GenAI-derived interpretations, may be stored in a database of sequential rules. In addition, in one example, the present disclosure may apply these sequential rules to additional sequences of NF transaction events associated with failed mobility transactions.

In one example, sequences may be applied to a sequential rule mining (SRM) algorithm, e.g., implemented by a processing system of the present disclosure, to extract the rules from the example sequences. A sequential rule (also called an episode rule, temporal rule or, prediction rule) indicates that if some event(s) occurs, some other subsequent event(s) are also likely to occur with a given confidence or probability. In accordance with the present disclosure, sequential rule mining may be applied to sequences of NF failure events appearing in failed mobility transactions to generate rules for predicting subsequent NF failures/failure events from prior NF failure events. The derived sequential rules may be maintained in the form P⇒Q (if P then Q). In this notation, P is a set of one or more NF failure events that occur earlier within a failed mobility transaction (the antecedent) and Q is the set of one or more NF failure events that occur subsequently within a failed mobility transaction (the consequent). If the probability is set to 1, then these rules are purely predictive, since if P occurs, then with probability 1, Q must occur (e.g., using the prior sequences of NF failure events as the ground truth).

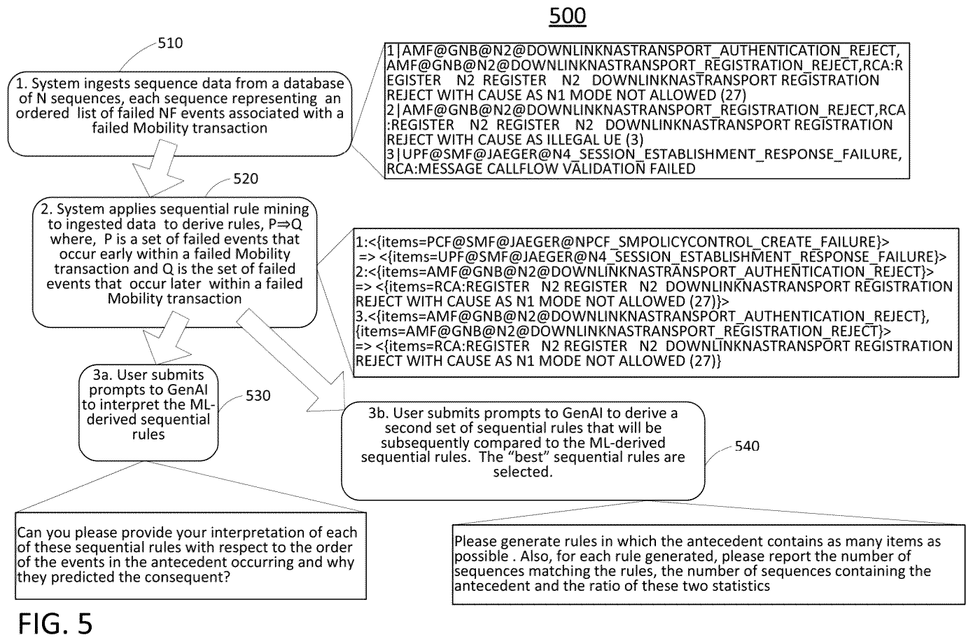

Examples of the present disclosure may further include one or more options for applying literature-based discovery (LBD) and knowledge-enhanced context capabilities of generative models to interpret and enhance these SRM-derived rules. For instance, in a first example, a user may submit a prompt to a generative model to interpret the derived sequential rules (and/or the present disclosure may run a generative model using an automatically defined prompt). For instance, FIGS. 5, 7, and 9-13 illustrate prompts/queries that may comprise inputs to a generative model, e.g., a large language model (LLM) or the like. In one example, queries/prompts to a generative model may be “careful” prompts, e.g., in which sequential rule documentation is embedded within the prompt content, and/or in which one or more sequences may be similarly embedded, or accessed from a database of N sequences and added to the prompt content. Alternatively, or in addition, in one example, information relevant to the mobility/cellular network domain may be embedded within the prompt, provided along with the prompt, and/or retrieved based upon the content of the prompt. For instance, examples of the present disclosure may supplement the prompts and capabilities of the generative model using retrieval augmented generation (RAG). In one example, a prompt may be applied as an input to a generative model to derive a second set of sequential rules (e.g., GenAI-derived sequential rules) based on failed event sequences incorporated within the prompt, which may be compared to the initial SRM-derived rule set to select the “best” sequential rules (e.g., those rules appearing in both the first and second sets).

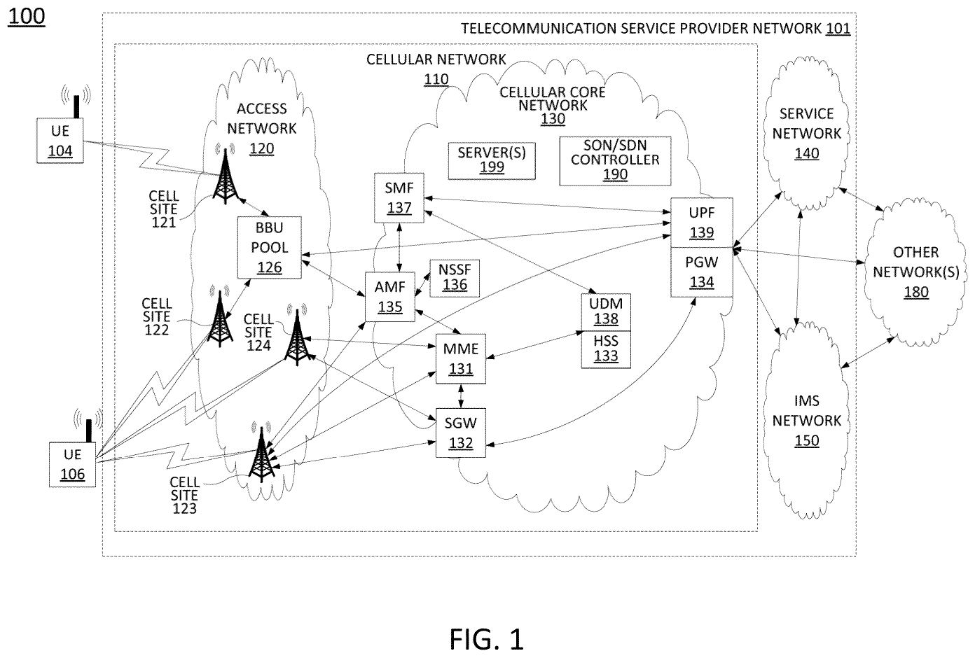

In one example, example one, new sequences of NF failure events may be scanned in near-real time for rule matching to detect whether a new observed ordered sequence of NF failure events matches the antecedent and consequent of a sequential rule in the sequential rule database. If yes, then an alert may be generated incorporating these existing sequential rules (with matching antecedent and consequent) and interpretations for distribution to one or more recipient devices. In one example, example two, new sequences of NF failure events may be scanned in near-real time for rule matching to detect whether a new observed ordered sequence of NF failure events matches the antecedent of a sequential rule in the sequential rule database. If yes, then an alert may be generated incorporating these existing sequential rules (with matching antecedent but different consequents) and interpretations for distribution to one or more recipient devices. In one example, example three, new sequences of NF failure events may be scanned in near-real time for rule matching to detect whether a new observed ordered sequence of NF failure events matches a consequent of a sequential rule in the sequential rule database. If yes, then an alert may be generated incorporating these existing sequential rules (with matching consequent but different antecedents) and interpretations for distribution to one or more recipient devices. In example one, a network operator may determine causality in failed mobility transactions by attributing the cause of later NF failure events to one or more preceding NF failure events. In example two, a network operator may predict future NF failure events from currently observed NF failure events. In example three, a network operator may receive information on new antecedents of current NF failure events. As such, examples of the present disclosure reduce delay in network troubleshooting, root cause identification, and resolution. These and other aspects of the present disclosure are discussed in greater detail below in connection with the examples of FIGS. 1-16.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, and so forth.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, UPF 139, and/or server(s) 199 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular core network 130 may also include a self-optimizing network (SON)/software defined network (SDN) controller 190. In one example, SON/SDN controller 190 may function as a self-optimizing network (SON) orchestrator that is responsible for activating and deactivating, allocating and deallocating, and otherwise managing a variety of network components. For instance, SON/SDN controller 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SON/SDN controller 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SON/SDN controller 190 may be connected directly or indirectly to any one or more network elements of cellular core network 130, and of the system 100 in general. Due to the relatively large number of connections available between SON/SDN controller 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, UPF 139, and/or server(s) 199 and other components of system 100 are also omitted for clarity, such as additional routers, switches, gateways, and the like.

FIG. 1 also illustrates various endpoint devices, e.g., user equipment (UE) 104 and 106. UE 104 and 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

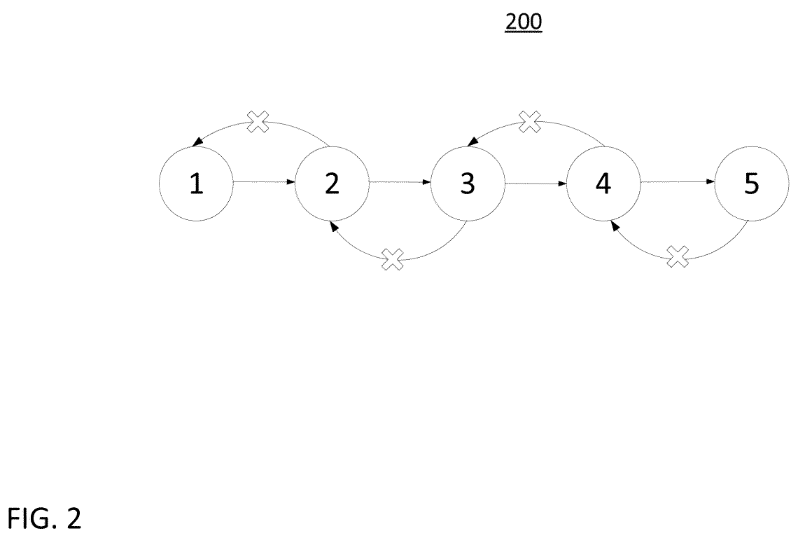

As noted above, NFs may interact in various end-to-end transactions. For instance, UE 104, a RAN/gNB (e.g., cell site 121 and BBU pool 126), AMF 135, SMF 137, and UPF 139 may engage in a sequence of messages/interactions for a protocol data unit (PDU) session establishment. To further illustrate, UE 104 may transmit a PDU session establishment request to AMF 135. In response, AMF 135 may transmit a create session management context request to SMF 137. The SMF 137 may then retrieve subscription data relating to UE 104 (and/or relating to the user thereof) from UDM 138, may select a PCF, and may transmit QFI to the UPF 139. UPF 139 may respond to SMF 137 with a tunnel endpoint identifier (TEID) for UPF 139. SMF 137 may then transmit a create session management context response message to AMF 135 along with N1/N2 messages. AMF 135 may forward N2 messages to the gNB (e.g., cell site 121 and BBU pool 126) and may forward N1 messages to the UE 103, thus establishing a DRB. The gNB may transmit a TEID to AMF 135, which may pass the TEID to SMF 137, which may transmit session modification information containing the gNB TEID to UPF 139 which may thus recreate the PDU session between UE 104 and UPF 139. In the event of a failed transaction, such as a PDU session establishment failure, NFs participating in the transaction may emit time-stamped event notifications signaling the failed outcome. From such a sequence of event notifications, the present disclosure may distinguish primary from secondary processing failures during transaction execution. In this regard, an example sequence of failure event notifications are illustrated in FIG. 2 and described in greater detail below.

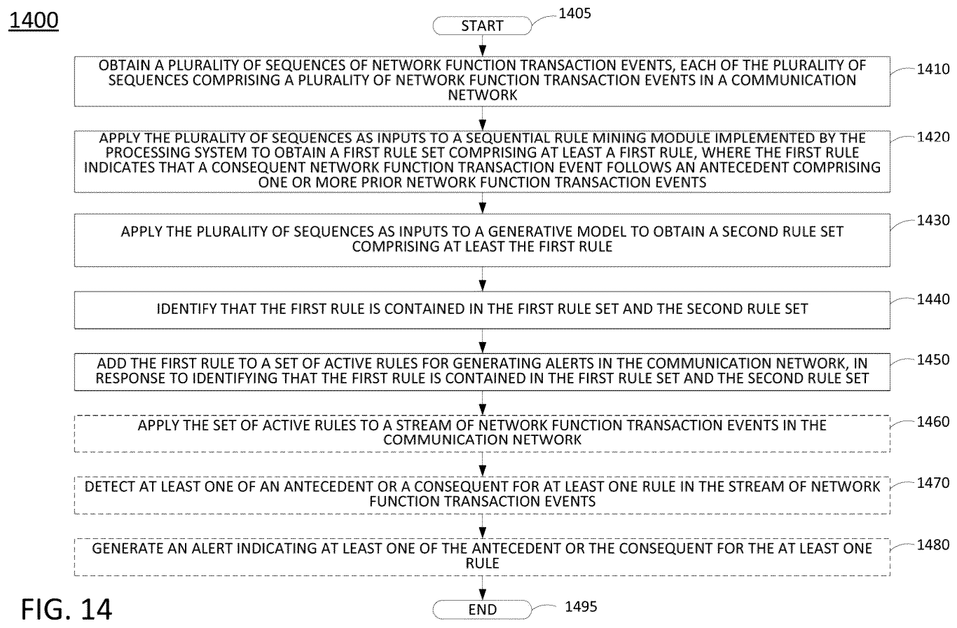

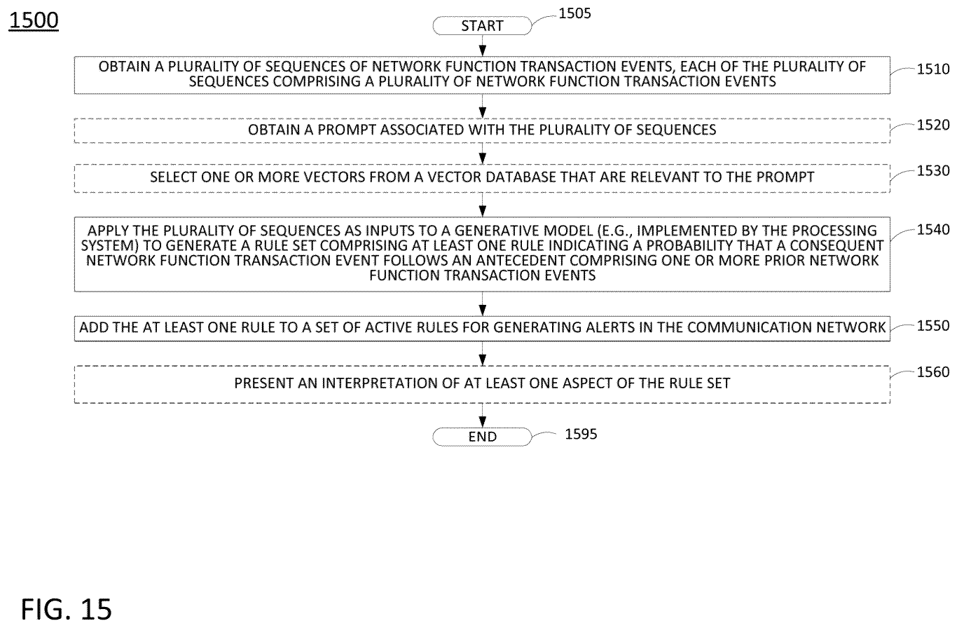

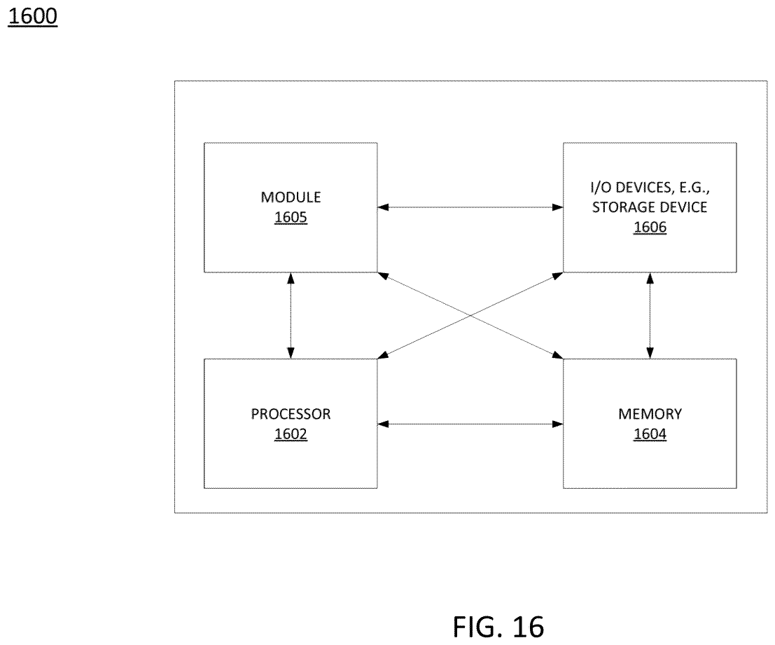

In one example, aspects of the present disclosure for adding a rule to a set of active rules for generating alerts in a communication network when the rule is contained in both a first rule set obtained via a sequential rule mining and a second rule set obtained via a generative model, e.g., as described in greater detail below in connection with the example method 1400 of FIG. 14, may be performed by one or more of server(s) 199, e.g., one or more application servers. In this regard, server(s) 199 may comprise all or a portion of a computing device or system, such as computing system 1600, and/or processing system 1602 as described in connection with FIG. 16 below, and may be configured to perform various operations in connection with examples of the present disclosure for adding a rule to a set of active rules for generating alerts in a communication network when the rule is contained in both a first rule set obtained via a sequential rule mining and a second rule set obtained via a generative model. Likewise, in one example, aspects of the present disclosure for applying a plurality of sequences as inputs to a generative model to generate a rule set comprising at least one rule indicating a probability that a consequent network function transaction event follows, e.g., as described in greater detail below in connection with the example method 1500 of FIG. 15, may be performed by server(s) 199. For instance, server(s) 199 may obtain and store sequences of time-stamped NF failure events from which sequential rules may be derived, e.g., via sequential rule mining and/or via application to generative model(s). In addition, server(s) 199 may further scan new/additional sequences of time-stamped NF failure events for rule matching and alerting, and so forth. In one example, server(s) 199 may include a document repository and/or vector database, e.g., that may be used for retrieval augmented generation (RAG), as described herein.

It should also be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 16 and discussed below) or multiple computing devices collectively configured to perform various steps, functions, and/or operations in accordance with the present disclosure.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), a network data analytics functions (NWDAF), and other application functions (AFs). In one example, server(s) 199 may comprise one or more NFs having extended functionality in accordance with the present discourse. For instance, server(s) 199 may include an NWDAF, which may determine sequential rules from sample sequences of NF failure event notifications, which may scan sequences for rule matching and alerting, and so forth.

In one example, any one or more of cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions as described above. Thus, these and other modifications are all contemplated within the scope of the present disclosure.

FIG. 2 illustrates an example sequence 200 of network function transaction events (e.g., failure events) for a mobility network transaction involving network functions (NFs) 1-5. In this case, the transaction is synchronized. A downstream NF initiates a request for service to an upstream NF and waits until it receives back a response. For instance, NF1 initially submits a request for service to NF2, which in turn submits a request for service to NF3, which in turn submits a request for service to NF4, and which submits a request for service to NF5. In one example, if NF5 fails, it may emit a time-stamped failure event message which may be sent to down-stream NF4, which in turn may emit a time-stamped failure event and send a failure event message to down-stream NF3, etc. The most down-stream NF, e.g., NF 1, may also fail and emit a time-stamped failure event/failure event message.

Notably, all of the NFs 1-5 participating in the transaction may emit time-stamped failure event messages signaling a failed outcome. In accordance with the present disclosure, the sequence of failure events/failure event messages may be used to derive causality in the failed transaction shown in FIG. 2, and hence for resolving the underlying network issue. To illustrate, a “primary NF” may refer to an NF that fails earlier in a failed transaction flow than subsequent “failing” NF(s) and, furthermore, which is always followed by these one or more subsequent “failing” NF(s) (or is followed with a particular probability/likelihood above a threshold, or the like). In contrast, a “secondary NF” may refer to a failed NF with a failure event/failure event message that occur later in the failed transaction flow than that of the primary NF and, furthermore, which always fails whenever a primary NF also fails (or which follows with a particular probability/likelihood above a threshold, or the like).

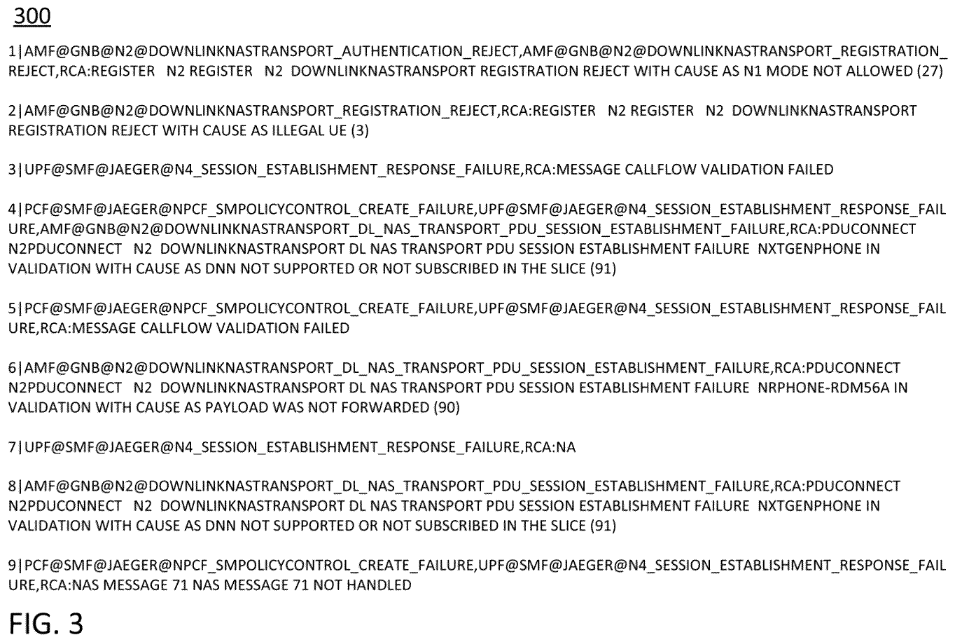

FIG. 3 illustrates nine example sequences 300 of network function transaction events (e.g., failure events/failure event messages) for several mobility network transactions involving various network functions (NFs). It should be noted that the first two sequences 1 and 2 represent sequences of ordered NF failure events, separated by the delineator “,” observed in failed INITIAL_REGISTATION transactions. Similarly, sequences 3-9 represent sequences of ordered NF failure events, separated by the delineator “,” observed in failed PDU_SESSION_ESTABLISHMENT transactions. In addition, in the example of FIG. 3 each NF failure event in a sequence is represented as an “@” delineated 4-tuple. The first element of the 4-tuple represents the NF that initiated the request, the second element represents the NF receiving the request, the third element is the logical interface between the NFs, and the fourth element is the message returned by the recipient of the request (e.g., a failure event message/failure event message content).

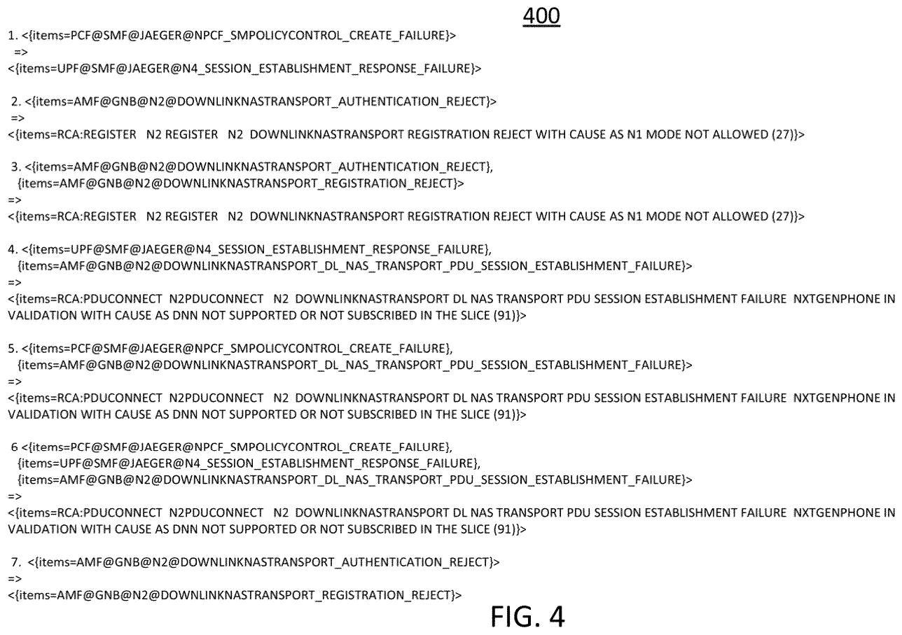

FIG. 4 illustrates an example set 400 of sequential rules that may be derived from sequential rule mining. In particular, in the example of FIG. 4, seven rules, 1-7, may be derived from the example sequences 300 of FIG. 3. It should be noted that in the present example each of the rules 1-7 may be of the form P⇒Q (if P then Q) based on a confidence or probability of 1.0. However, in other examples, a probability/confidence of less than 1.0 may be set as a parameter of the sequential rule mining. In each case, an antecedent, P, may comprise one or multiple failure events, and a consequent, Q, may comprise an additional failure event that occurs with probability 1 when the antecedent is encountered. Similar to the example, of FIG. 3, the notation of sequential rules in the set 400 may comprise an “@” delineated 4-tuple for P and an “@” delineated 4-tuple for Q. The first element of the 4-tuple represents the NF that initiated the request, the second element represents the NF receiving the request, the third element is the logical interface between the NFs, and the fourth element is the message returned by the recipient of the request (e.g., a failure event message/failure event message content).

In one example, sequences may be applied to a sequential rule mining algorithm, e.g., implemented by a processing system of the present disclosure, to extract the rules from a set of example sequences. A sequential rule (also called episode rule, temporal rule or prediction rule) indicates that if some event(s) occurs, some other subsequent event(s) are also likely to occur with a given confidence or probability. FIG. 5 illustrates an example process 500, or method for processing a prompt via a generative model to generate an interpretation at least one aspect of a rule set obtained via a sequential rule mining module, the rule set including at least one rule indicating a probability that a consequent network function transaction event follows an antecedent comprising one or more prior network function transaction events, in accordance with the present disclosure. For instance, at 510 a processing system may first ingest sequences of NF failure events/failure event messages from a database of N sequences, each sequence representing an ordered list of NF failure events associated with a failed mobility transaction (such as sequences 505). At 520, the processing system may then apply sequential rule mining to the ingested data to derive sequential rules, e.g., sequential rules 525 of the form P⇒Q, where P is a set of one or more NF failure events that occur earlier within a failed mobility transaction (the antecedent) and Q is the set of one or more NF failure events that occur subsequently within a failed mobility transaction (the consequent). In one example, at 530 the processing system may next submit one or more prompts to a generative model (e.g., an AI-based and/or ML-based model) to interpret the SRM-derived sequential rules. For instance, an example prompt 535 may be: “Can you please provide your interpretation of each of these sequential rules with respect to the order of the events in the antecedent occurring and why they predicted the consequent?”. In one example, the sequential rules may be provided as part of the prompt or along with the prompt, or the processing system may be directed as to where the sequential rules may be obtained. In one example, at 540 the processing system may alternatively or additionally submit one or more prompts to the same or a different generative model to derive a second set of sequential rules that may be subsequently compared to the SRM-derived sequential rules. For instance, an example prompt 545 may be: “Please generate rules in which the antecedent contains as many items as possible. Also, for each rule generated, please report the number of sequences matching the rules, the number of sequences containing the antecedent and the ratio of these two statistics.” In one example, the sequences may be provided as part of the prompt or along with the prompt, or the processing system may be directed as to where the sequences may be obtained. Sequential rules appearing in both sets may be selected for a final set of sequential rules.

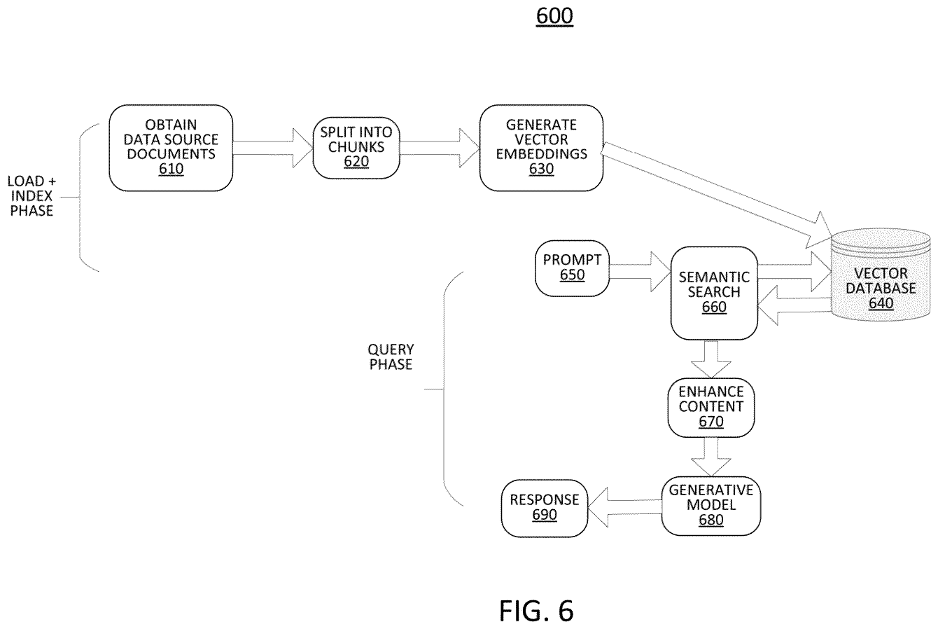

FIG. 6 illustrates an example process 600 for a retrieval augmented generation (RAG), in accordance with the present disclosure. To illustrate, at 610, a processing system may obtain data source documents, e.g., in electronic text format(s), such as technical whitepapers, instruction manuals, etc. The data source documents may be internal documents of an enterprise or another organization operating the processing system, or may be public source documents, purchased or licensed documents, or other documents that are authorized to be utilized by an operator of the processing system. In any case, at 620, the data source documents may be chunked, or segmented, e.g., split into chunks/segments of the same or various lengths. For instance, the chunking/segmenting may be according to any one of a number of chunking/segmenting algorithms, such as a sliding window segmentation, sentence-level splitting, sentence-level splitting with removal of stop words, and so forth. In one example, documents may be in a mixed media format, such as including text and images, which may also include captions, as well as news, magazine, and/or general webpage layouts, which may guide the chunking using visual cues or other aspects according to various algorithms. For instance, paragraphs may be visually distinguished from one another for readability, such as using extra space between paragraphs and around paragraphs, and so forth.

At 630, the processing system may generate vectors/vector embeddings of the chunked documents, such as using word2vec and/or doc2vec, and so forth.

At 640, the processing system may add the vector embeddings to a vector database. For instance, the vector database may be internal to an enterprise or another organization operating the processing system, or may be a shared vector database among collaborating enterprises, etc.

At 650, the processing system may receive a prompt. For example, an operator or a user may provide the prompt.

At 660, the processing system may perform a search over the vector database based upon the prompt, e.g., a semantic search. For instance, the prompt may be similarly vectorized and the vectors/vector embeddings of the prompt may be compared to vectors in the vector database to find the closest matching vectors. In one example, the identified vectors may be joined with the prompt at 670 to create an enhanced prompt content comprising an input/input data set for a generative model (e.g., a large language model (LLM)) at 680. In one example, the generative model may be implemented by the processing system.

At 690, the processing system may therefore generate a response to the prompt via the LLM, and provide the response as an output of the process flow 600. It should be noted that FIG. 6 illustrates just one example of a retrieval augmented generation process, and that other, further, and different examples may be implemented in a different manner in accordance with the present disclosure. For instance, in one example, the prompt may identify specific documents to be used for augmentation/enhancement. As such, the search of the vector database may be specifically directed rather than using a semantic search. Alternatively, or in addition, the relevant data sources/documents may be provided as part of the query or accompanying the query. Similarly, the query may specify where relevant data source documents may be obtained for subsequent chunking, vectorization, and storage at 620-640. Thus, these and other modifications are all contemplated within the scope of the present disclosure.

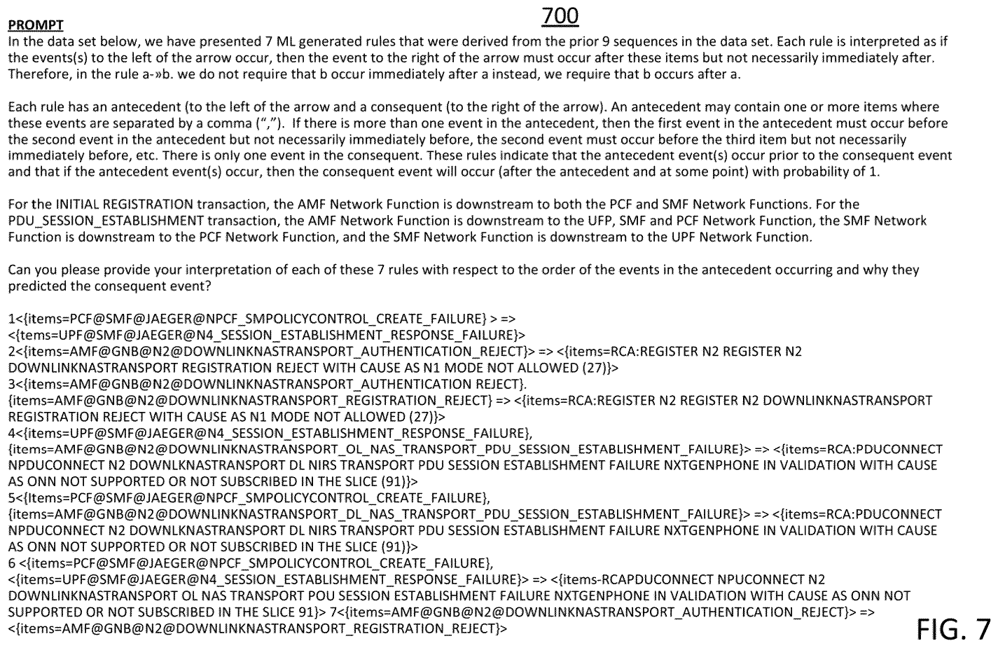

FIG. 7 illustrates an example prompt 700 according to the present disclosure. Notably, the example prompt 700 includes relevant background information, a natural language query/request, as well as the specific rules that pertain to the query/request. The rules syntax may be the same or similar as described above.

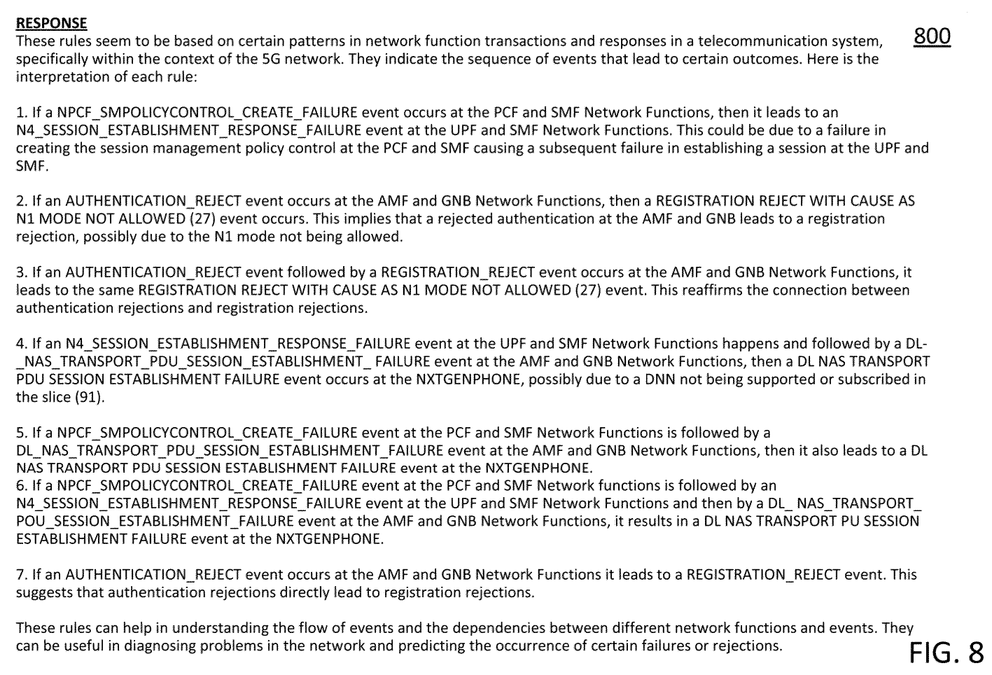

FIG. 8 illustrates an example response 800 (e.g., which may be generated via a generative model in response to the prompt 700 of FIG. 7). In particular, the prompt 700 of FIG. 7 requests an interpretation of each rule, (e.g., “Can you please provide your interpretation of each of these 7 rules with respect to the order of the events in the antecedent occurring and why they predicted the consequent event?”). The response 800 addresses each of these rules, providing a concise interpretation. In one example, the response 800 may be created via a generative model, e.g., an LLM. In addition, in one example, the generative model may be implemented in accordance with a retrieval augmented generation (RAG) process, such as illustrated in FIG. 6 and described above. As such, the generative model may provide the response 800 having a more particularized interpretation that is specific to the 5G mobility domain and/or a particular cellular network associated with the processing system and/or the user thereof using additional documentation that is relevant to the contents of prompt 700.

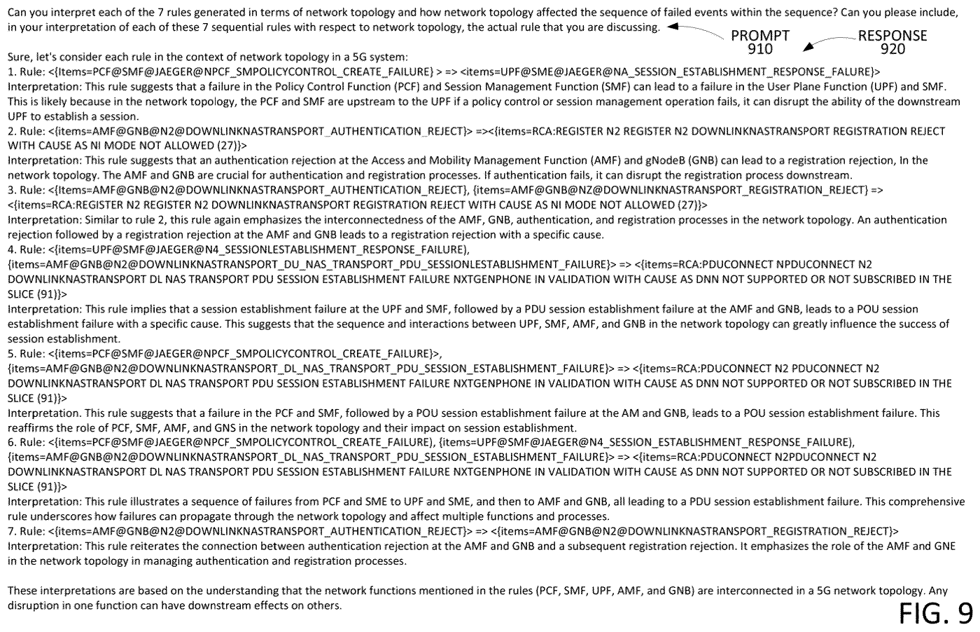

FIG. 9 illustrates an additional prompt 910 and response 920 of a generative model in accordance with the present disclosure. In one example, the prompt 910 may be a follow-on to the prompt 700 of FIG. 7. Thus, for example, where the prompt 910 states “Can you interpret each of the 7 rules generated in terms of network topology and how network topology affected the sequence of failed events within the sequence? Can you please include, in your interpretation of each of these 7 sequential rules with respect to network topology, the actual rule that you are discussing,” the generative model may retain prior context from the prompt 700, in particular the rules in question that are referenced in the additional prompt 910. In this case, the response 920 restates each rule followed by a concise interpretation of the respective rule. In addition, the response is also particularized to the 5G mobility domain. For instance, as noted above, the generative model (e.g., an LLM) may be implemented in accordance with a retrieval augmented generation (RAG) process, such as illustrated in FIG. 6 and described above.

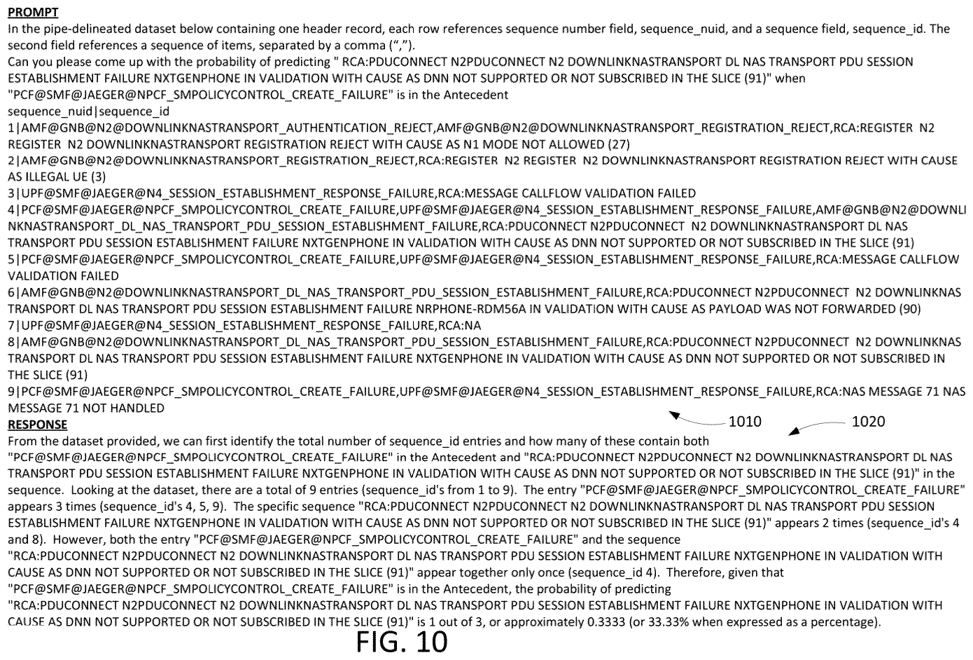

It should be noted that the examples of FIGS. 7-9 relate to generating interpretations of sequential rules via a generative model, where the rules may be generated via a different process (e.g., sequential rule mining (SRM)). FIG. 10 illustrates an additional example of the present disclosure in which a rule, or rules may be extracted via a generative model (e.g., an LLM). In particular, a prompt 1010 may include a query/request: “Can you please come up with the probability of predicting” RCA: PDUCONNECT N2PDUCONNECT N2 DOWNLINKNASTRANSPORT DL NAS TRANSPORT PDU SESSION ESTABLISHMENT FAILURE NXTGENPHONE IN VALIDATION WITH CAUSE AS DNN NOT SUPPORTED OR NOT SUBSCRIBED IN THE SLICE (91) “when ‘PCF@SMF@JAEGER@NPCF_SMPOLICYCONTROL_CREATE_FAILURE’ is in the Antecedent.” The prompt 1010 also includes a dataset of sequences for analysis via the generative model and the additional information: “In the pipe-delineated dataset below containing one header record, each row references sequence number field, sequence_nuid, and a sequence field, sequence_id. The second field references a sequence of items, separated by a comma (‘,’).” In this case, the response 1020 includes an actual numeric answer expressed as a percentage. In addition, the response provides a step-by-step process that may guide a person reading the response as to how the numeric answer was achieved.

The query 1010 and the response 1020 demonstrate that a generative model is capable of analyzing data sets comprising failure message sequences to derive sequential rules. In particular, the query 1010 asks for a probability of predicting a given rule based on a set of failure message sequences. The generative model is able to determine the correct probability/percentage, from which a sequential rule may then be determined/declared in a formulaic manner based upon a probability/percentage threshold. For instance, if the threshold is set to 1.0, a sequential rule may be declared when a probability/percentage found in the same manner as illustrated in FIG. 10 is 1.0. Where the threshold is another value, e.g., 0.91, when a probability/percentage found in the same manner as illustrated in FIG. 10 is 0.91 or greater, a sequential rule may be declared to be found.

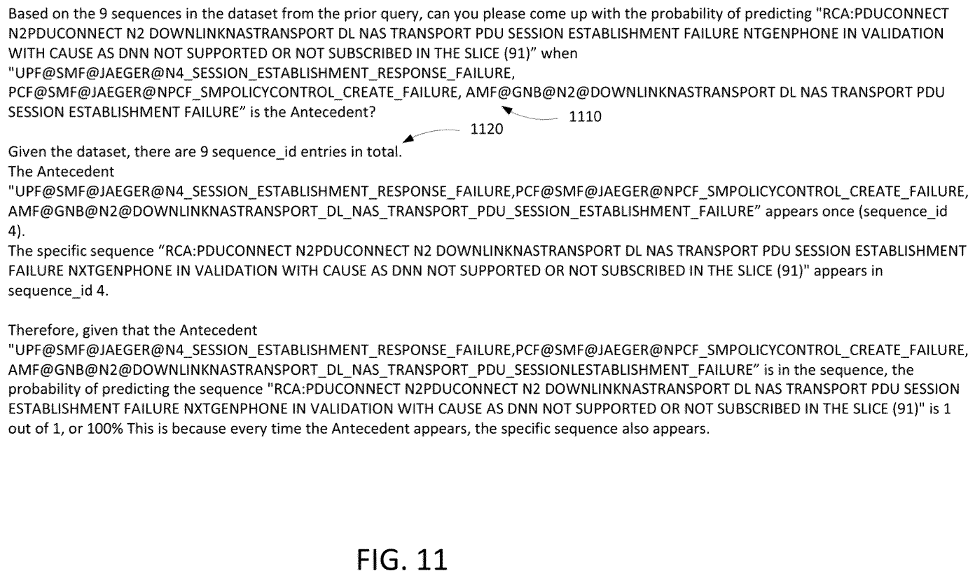

In this regard, FIG. 11 illustrates an additional example of the present disclosure in which a rule, or rules may be extracted via a generative model (e.g., an LLM). For instance, the query 1110 refers to the same sequences from the example query 1010 of FIG. 10. The query 1110 asks specifically: “Based on the 9 sequences in the dataset from the prior query, can you please come up with the probability of predicting ‘RCA:PDUCONNECT N2PDUCONNECT N2 DOWNLINKNASTRANSPORT DL NAS TRANSPORT PDU SESSION ESTABLISHMENT FAILURE NTGENPHONE IN VALIDATION WITH CAUSE AS DNN NOT SUPPORTED OR NOT SUBSCRIBED IN THE SLICE (91)’ when ‘UPF@SMF@JAEGER@N4_SESSION_ESTABLISHMENT_RESPONSE_FAILUR E, PCF@SMF@JAEGER@NPCF_SMPOLICYCONTROL_CREATE_FAILURE, AMF@GNB@N2@DOWNLINKNASTRANSPORT DL NAS TRANSPORT PDU SESSION ESTABLISHMENT FAILURE’ is the Antecedent?” In this case, the response 1120 includes a correct numeric answer expressed as a percentage (1.0). In addition, the response provides a step-by-step process that may guide a person reading the response as to how the numeric answer was achieved. In addition, “UPF@SMF@JAEGER@N4_SESSION_ESTABLISHMENT_RESPONSE_FAILU RE, PCF@SMF@JAEGER@NPCF_SMPOLICYCONTROL_CREATE_FAILURE, AMF@GNB@N2@DOWNLINKNASTRANSPORT DL NAS TRANSPORT PDU SESSION ESTABLISHMENT FAILURE=>RCA:PDUCONNECT N2PDUCONNECT N2 DOWNLINKNASTRANSPORT DL NAS TRANSPORT PDU SESSION ESTABLISHMENT FAILURE NTGENPHONE IN VALIDATION WITH CAUSE AS DNN NOT SUPPORTED OR NOT SUBSCRIBED IN THE SLICE (91)” may be declared as a sequential rule insofar as the probability/percentage of 100% meets or exceeds a sequential rule probability threshold, e.g., defined by a network operator, or the like.

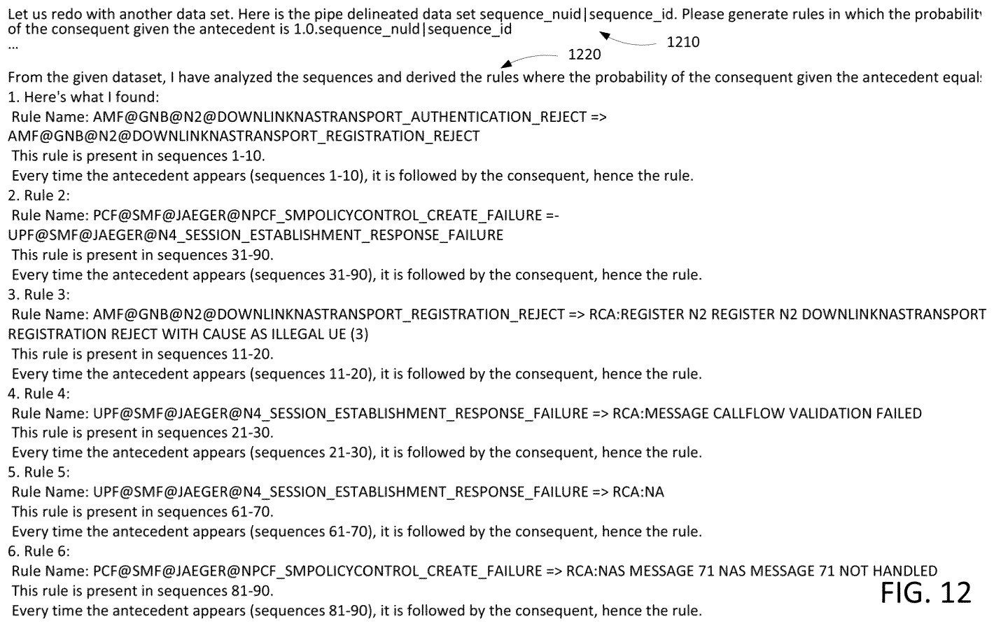

FIG. 12 illustrates an example query/prompt and response containing rules identified via a generative model (e.g., an LLM). In particular, the prompt 1210 requests the identification of sequential rules with a probability of 1.0, given a data set of example sequences of NF failure event (for ease of illustration, the actual sequences are omitted from FIG. 1). However, it should be understood that there are at least 90 sequences. In the present example, the generative model may determine six rules, which are recited in the form P=>Q using the same notation as in the preceding examples. In addition, each of the six rules is accompanied by a concise explanation of how/why the rule was found based upon the data set of NF failure event sequences. It should be noted that the example of FIG. 12 is illustrative in nature and that an actual response generated from an LLM-based generative model in response to the prompt 1210 may be different.

Similarly, the response 1220 in the example of FIG. 12 may vary from responses that may be generated via various different generative models in response to the prompt 1210. For instance, the response 1220 may be generated via an LLM-based generative model that further includes or is used in conjunction with retrieval augmented generation (RAG) using a knowledge-base of vectorized documentation. However, a different response may be generated via a generative model that does not utilize RAG and/or that does not utilize the same knowledge base of vectorized documentation.

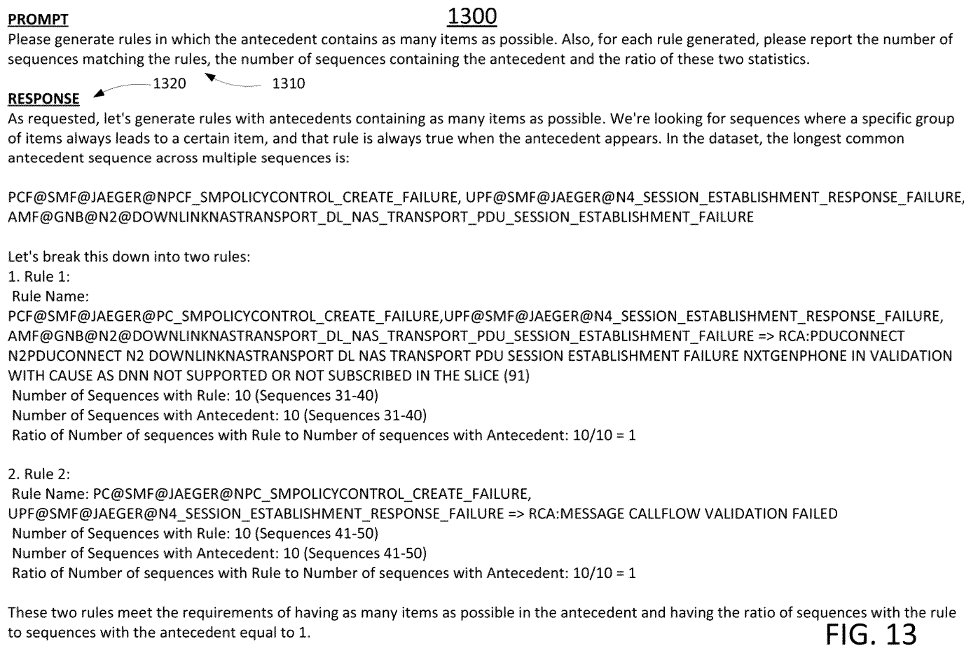

FIG. 13 illustrates still another example query/prompt and response containing rules identified via a generative model (e.g., an LLM). In particular, the prompt 1310 asks: “Please generate rules in which the antecedent contains as many items as possible. Also, for each rule generated, please report the number of sequences matching the rules, the number of sequences containing the antecedent and the ratio of these two statistics.” In the present example, the assumed data set may be the same as in the preceding example of FIG. 12. In addition, the generative model may retain prior context from the prompt 1210 in the preceding example of FIG. 12 (e.g., the data set, as well as the given threshold percentage/likelihood of 1.0 for declaring a sequential rule to exist). In this case, the generative model may determine two rules in the response 1320, which are recited in the form P=>Q using the same notation as in the preceding examples. In addition, each of the two rules is accompanied by a concise explanation of how/why the rule was found based upon the underlying data set of NF failure event sequences. It should be similarly noted that the example of FIG. 13 is illustrative in nature and that an actual response generated from an LLM-based generative model in response to the prompt 1310 may be different depending upon the given data set, the configuration of the generative model, and so forth.

FIG. 14 illustrates a flowchart of an example method 1400 for adding a rule to a set of active rules for generating alerts in a communication network when the rule is contained in both a first rule set obtained via a sequential rule mining and a second rule set obtained via a generative model, in accordance with the present disclosure. In one example, steps, functions and/or operations of the method 1400 may be performed by a device, or devices, as illustrated in FIG. 1, e.g., server(s) 199, or any one or more components thereof, such as a processing system, or collectively via a plurality devices in FIG. 1, such as one or more of server(s) 199 in conjunction with SON/SDN controller 190, AMF 135, NSSF 136, SMF 137, UPF 139, and so forth. In one example, the steps, functions, or operations of method 1400 may be performed by a computing device or system 1600, and/or a processing system 1602 as described in connection with FIG. 16 below. For instance, the computing device 1600 may represent at least a portion of server(s) 199 in accordance with the present disclosure. For illustrative purposes, the method 1400 is described in greater detail below in connection with an example performed by a processing system, such as processing system 1602. The method 1400 begins in step 1405 and proceeds to step 1410.

At step 1410, the processing system obtains a plurality of sequences of network function (NF) transaction events, each of the plurality of sequences comprising a plurality of network function transaction events in a communication network. As discussed above, the plurality of network function transaction events may be associated with a plurality of cellular network function instances (e.g., virtual and/or physical NFs) of the communication network. For instance, the NF transaction events may comprise NF failure events/failure event messages.

At step 1420, the processing system applies the plurality of sequences as inputs to a sequential rule mining module implemented by the processing system to obtain a first rule set comprising at least a first rule, where the first rule indicates that a consequent network function transaction event follows an antecedent comprising one or more prior network function transaction events. For example, the first rule may indicate a probability that the consequent network function transaction event follows the antecedent, or may indicate that the probability exceeds a threshold. For instance, in one example the probability and/or the threshold may be 1 (1.0 or 100%). In other example, a sequential rule may be found where the probability is less than 1.0/100% (e.g., 0.9/90%, 0.85/85%, etc.). In one example, the first rule may be in the form P=>Q (if P then Q) using the same notation as in the preceding examples, such as any of the seven rules illustrated in FIG. 7, or the like. As noted above, the sequential rule mining module (e.g., a sequential rule mining process/algorithm implemented by the processing system) may comprise: a PrefixSpan (Prefix-Projected Sequential Pattern Mining algorithm, a GSP (Generalized Sequential Pattern) algorithm, a SPADE (Sequential PAttern Discovery using Equivalence classes) algorithm. an ERMiner (Efficient Rule Miner) algorithm, a RuleGrowth algorithm, a CMRules (Class Association Rules for Sequential Patterns) algorithm, a RuleGen algorithm, or the like.

At step 1430, the processing system applies the plurality of sequences as inputs to a generative model to obtain a second rule set comprising at least the first rule. For instance, as discussed above, the generative model may comprise a large language model (LLM). In one example, the generative model, e.g., an LLM, may comprise a generative pre-trained transformer model. For instance, in accordance with the present disclosure, a generative model (e.g., a machine learning model) may comprise a generative pre-trained transformer (GPT) model, a Large Language Model Meta AI (LLaMA) model, a Language Model for Dialogue Applications (LaMDA) model, a Pathways Language Model (PaLM) model, a bidirectional transformer that is pre-trained for language understanding/natural language processing (NLP) tasks (e.g., a Bidirectional Encoder Representations from Transformers (BERT) model), and so forth.

At step 1440, the processing system identifies that the first rule is contained in the first rule set and the second rule set. For instance, a rule that is found via both SRM and a generative model may be considered as a rule that may be used for alerting, forecasting/prediction, etc. (e.g., verified via two complementary methodologies).

At step 1450, the processing system adds the first rule to a set of active rules for generating alerts in the communication network, in response to identifying that the first rule is contained in the first rule set and the second rule set. For instance, at optional step 1460 the processing system may apply the set of active rules to a stream of network function transaction events in the communication network, at optional step 1470 the processing system may detect at least one of an antecedent or a consequent for at least one rule in the stream of network function transaction events, and at optional step 1480 the processing system may generate an alert indicating at least one of the antecedent or the consequent for the at least one rule. In particular, each time the antecedent is encountered, there is a likelihood that the consequent will follow. As such, the processing system may detect the antecedent and provide an alert that the consequent is expected to follow, e.g., with a given probability. Alternatively, if both the antecedent and consequent are observed, an alert may be generated for a particular NF transaction event, where the consequent may be appended to indicate that the network function transaction event is not isolated but is related to the observed prior NF transaction events (e.g., one or more antecedent NF failure events). Alternatively, or in addition, when a consequent is encountered and the processing system, while scanning, determines that known antecedent(s) is/are not present, may generate an alert specifying the new antecedents, together with an observed consequent. Such types of information may then be used for various purposes in the communication network, such as root cause analysis (RCA), fault isolation, etc.

Following step 1450, or any of the optional steps 1460-1480, the method 1400 may proceed to step 1495 where the method ends.

It should be noted that the method 1400 may be expanded to include additional steps or may be modified to include additional operations with respect to the steps outlined above, to remove operations, to perform operations in a different order, and so forth. For instance, in one example, the method 1400 may be expanded to include generating an interpretation of at least one aspect of the rule set (e.g., via the same generative model as described in connection with step 1430, or a different generative model) and presenting the interpretation of the at least one aspect of the rule set. In one example, the method 1400 may replace steps 1430-1450 with these steps or may modify step 1430 to include the generating of the interpretation. In one example, the method 1400 may include obtaining a prompt for the generative model, where the applying of step 1430 may be in response to/in accordance with the prompt. In one example, the prompt may be obtained from a client system and an interpretation obtained via the generative model may be presented to the client system. Alternatively, the prompt may be automatically generated. For instance, it may be assumed that any use of the processing system is at least for the purpose of obtaining the interpretations of one or more sequential rules. In one example, the applying of the plurality of sequences as inputs to the generative model at step 1430 may further incorporate a retrieval augmented generation (RAG) as described herein. In one example, the method 1400 may be expanded or modified to include steps, functions, and/or operations, or other features described above in connection with the example(s) of FIGS. 1-13, 15, and/or 16, or as described elsewhere herein. Thus, these and other modifications are all contemplated within the scope of the present disclosure.

FIG. 15 illustrates a flowchart of an example method 1500 for applying a plurality of sequences as inputs to a generative model to generate a rule set comprising at least one rule indicating a probability that a consequent network function transaction event follows an antecedent comprising one or more prior network function transaction events. In one example, steps, functions and/or operations of the method 1500 may be performed by a device, or devices, as illustrated in FIG. 1, e.g., server(s) 199, or any one or more components thereof, such as a processing system, or collectively via a plurality devices in FIG. 1, such as one or more of server(s) 199 in conjunction with SON/SDN controller 190, AMF 135, NSSF 136, SMF 137, UPF 139, and so forth. In one example, the steps, functions, or operations of method 1500 may be performed by a computing device or system 1600, and/or a processing system 1602 as described in connection with FIG. 16 below. For instance, the computing device 1600 may represent at least a portion of server(s) 199 in accordance with the present disclosure. For illustrative purposes, the method 1500 is described in greater detail below in connection with an example performed by a processing system, such as processing system 1602. The method 1500 begins in step 1505 and proceeds to step 1510.

At step 1510, the processing system obtains a plurality of sequences of network function transaction events, each of the plurality of sequences comprising a plurality of network function transaction events. For instance, step 1510 may comprise the same or similar operations as described above in connection with step 1410 of the example method 1400 of FIG. 14.

At optional step 1520, the processing system may obtain a prompt associated with the plurality of sequences. In one example, the prompt may include a request for an interpretation of at least one aspect of a rule set (e.g., to be obtained at step 1540). In one example, the prompt may be obtained from a client system, e.g., from a user endpoint device of a user, such as a computer, a mobile computing device, e.g., a smartphone, a wearable computing device, a cloud desktop, etc. In one example, the prompt may specify a threshold probability for determining a sequential rule. However, in another example, the threshold may be pre-defined or may be specified in a different manner, e.g., a user input to select the threshold as a global setting for the processing system, etc.

At optional step 1530, the processing system may select one or more vectors from a vector database that are relevant to the prompt. For instance, the one or more vectors may comprise vectorized text from one or more data sources. The vector database may be internal to an enterprise or other organization operating the processing system, may be a shared vector database among collaborating enterprises, etc. The vectors may be obtained by vectorizing the prompt, e.g., via word2vec, doc2vec, or the like, and the relevance may be determined by comparing the vectors of the prompt to vectors in the vector database to find the top matches, e.g., the top N matches, or the like (e.g., according to a distance metric within a vector feature space, such as a Euclidean distance, a Manhattan distance, etc.). For instance, vectors within the vector database within a threshold distance to vectors of the prompt may be selected.

At step 1540, the processing system applies the plurality of sequences as inputs to a generative model (e.g., implemented by the processing system) to generate a rule set comprising at least one rule indicating a probability that a consequent network function transaction event follows an antecedent comprising one or more prior network function transaction events. For instance, as noted above, the generative model may comprise a large language model (LLM), e.g., a GPT model, a LLaMA model, a LaMDA model, a PaLM model, a bidirectional transformer that is pre-trained for language understanding/natural language processing (NLP) tasks (e.g., a BERT model), and so forth. In one example, the applying of the plurality of sequences as inputs to the generative model at step 1530 may be in response to the prompt that may be obtained at optional step 1520. In one example, step 1540 may include applying the one or more vectors as supplemental prompt content to the generative model, e.g., in one example, the selecting of the one or more vectors and the applying of the one or more vectors as the supplemental prompt content to the generative model may comprise a retrieval augmented generation (RAG) process. In one example, the applying of the plurality of sequences as inputs to the generative model at step 1540 may be further to generate an interpretation of the at least one aspect of the rule set.

At step 1550, the processing system adds the at least one rule to a set of active rules for generating alerts in the communication network.

At optional step 1560, the processing system may present the interpretation of at least one aspect of the rule set, e.g., in an example in which the interpretation is obtained at step 1540. In one example, the interpretation may be presented to a client system (e.g., the client system from which the prompt is received at optional step 1520, or another client system). For instance, the interpretation may be transmitted to the client system, e.g., a user endpoint device.

Following step 1550 and/or optional step 1560, the method 1500 may proceed to step 1595 where the method ends.

It should be noted that the method 1500 may be expanded to include additional steps or may be modified to include additional operations with respect to the steps outlined above, to remove operations, to perform operations in a different order, and so forth. For example, the method 1500 may include obtaining one or more user-provided data sources, vectorizing the data sources, and adding the vectors to the vector database. In one example, the method 1500 may further include operations of optional steps 1460-1480 of the example method 1400 of FIG. 14. In one example, the method 1500 may be expanded or modified to include steps, functions, and/or operations, or other features described above in connection with the example(s) of FIGS. 1-14 and/or 16, or as described elsewhere herein. Thus, these and other modifications are all contemplated within the scope of the present disclosure.

In addition, although not specifically specified, one or more steps, functions, or operations of the method 1400 or the method 1500 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 14 or FIG. 15 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 16 depicts a high-level block diagram of a computing device or processing system specifically programmed to perform the functions described herein. As depicted in FIG. 16, the processing system 1600 comprises one or more hardware processor elements 1602 (e.g., a central processing unit (CPU), a microprocessor, or a multi-core processor), a memory 1604 (e.g., random access memory (RAM) and/or read only memory (ROM)), a module 1605 for adding a rule to a set of active rules for generating alerts in a communication network when the rule is contained in both a first rule set obtained via a sequential rule mining and a second rule set obtained via a generative model and/or for applying a plurality of sequences as inputs to a generative model to generate a rule set comprising at least one rule indicating a probability that a consequent network function transaction event follows an antecedent comprising one or more prior network function transaction events, and various input/output devices 1606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 1606 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 1602 can also be configured or programmed to cause other devices to perform one or more operations as discussed above. In other words, the hardware processor 1602 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 1605 for adding a rule to a set of active rules for generating alerts in a communication network when the rule is contained in both a first rule set obtained via a sequential rule mining and a second rule set obtained via a generative model and/or for applying a plurality of sequences as inputs to a generative model to generate a rule set comprising at least one rule indicating a probability that a consequent network function transaction event follows an antecedent comprising one or more prior network function transaction events (e.g., a software program comprising computer-executable instructions) can be loaded into memory 1604 and executed by hardware processor element 1602 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 1605 for adding a rule to a set of active rules for generating alerts in a communication network when the rule is contained in both a first rule set obtained via a sequential rule mining and a second rule set obtained via a generative model and/or for applying a plurality of sequences as inputs to a generative model to generate a rule set comprising at least one rule indicating a probability that a consequent network function transaction event follows an antecedent comprising one or more prior network function transaction events (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system including at least one processor, a plurality of sequences of network function transaction events, each of the plurality of sequences comprising a plurality of network function transaction events in a communication network;
applying, by the processing system, the plurality of sequences as inputs to a sequential rule mining module implemented by the processing system to obtain a first rule set comprising at least a first rule, wherein the first rule indicates that a consequent network function transaction event follows an antecedent comprising one or more prior network function transaction events;
applying, by the processing system, the plurality of sequences as inputs to a generative model to obtain a second rule set;
identifying, by the processing system, that the first rule is contained in the first rule set and the second rule set; and
adding, by the processing system, the first rule to a set of active rules for generating alerts in the communication network, in response to identifying that the first rule is contained in the first rule set and the second rule set.

2. The method of claim 1, further comprising:
applying the set of active rules to a stream of network function transaction events in the communication network;
detecting at least one of: an antecedent or a consequent for at least one rule of the set of active rules in the stream of network function transaction events; and
generating an alert indicating at least one of: the antecedent or the consequent for the at least one rule.

3. The method of claim 1, wherein the first rule indicates a probability that the consequent network function transaction event follows the antecedent.

4. The method of claim 3, wherein the probability comprises a probability of 1.

5. The method of claim 1, wherein the plurality of network function transaction events comprises a plurality of network function event failures.

6. The method of claim 1, wherein the sequential rule mining module comprises:
a prefix-projected sequential pattern mining algorithm;
a generalized sequential pattern algorithm;
a sequential pattern discovery using equivalence classes algorithm;
an efficient rule miner algorithm;
a rulegrowth algorithm;
a class association rules for sequential patterns algorithm; or
a rulegen algorithm.

7. The method of claim 1, wherein the plurality of network function transaction events is associated with a plurality of cellular network function instances of the communication network.

8. The method of claim 1, wherein the generative model comprises a large language model-based machine learning model.

9. The method of claim 1, wherein the generative model comprises a generative pre-trained transformer model.

10. A non-transitory computer-readable medium storing instructions which, when executed by a processing system including at least one processor, cause the processing system to perform operations, the operations comprising:
obtaining a plurality of sequences of network function transaction events, each of the plurality of sequences comprising a plurality of network function transaction events in a communication network;
applying the plurality of sequences as inputs to a sequential rule mining module implemented by the processing system to obtain a first rule set comprising at least a first rule, wherein the first rule indicates that a consequent network function transaction event follows an antecedent comprising one or more prior network function transaction events;
applying the plurality of sequences as inputs to a generative model to obtain a second rule set;
identifying that the first rule is contained in the first rule set and the second rule set; and
adding the first rule to a set of active rules for generating alerts in the communication network, in response to identifying that the first rule is contained in the first rule set and the second rule set.

11. A method comprising:
obtaining, by a processing system including at least one processor, a plurality of sequences of network function transaction events, each of the plurality of sequences comprising a plurality of network function transaction events;
applying, by the processing system, the plurality of sequences as inputs to a generative model to generate a rule set comprising at least one rule indicating a probability that a consequent network function transaction event follows an antecedent comprising one or more prior network function transaction events; and
adding, by the processing system, the at least one rule to a set of active rules for generating alerts in a communication network.

12. The method of claim 11, further comprising:
obtaining a prompt associated with the plurality of sequences, wherein the applying of the plurality of sequences as inputs to the generative model is in response to the prompt.

13. The method of claim 12, further comprising:
selecting one or more vectors from a vector database that are relevant to the prompt, wherein the one or more vectors comprise vectorized text from one or more data sources, wherein the applying of the plurality of sequences as inputs to the generative model to obtain the rule set includes applying the one or more vectors as supplemental prompt content to the generative model.

14. The method of claim 13, wherein the selecting of the one or more vectors and the applying of the one or more vectors as the supplemental prompt content to the generative model comprise a retrieval augmented generation process.

15. The method of claim 12, wherein the prompt includes a request for an interpretation of at least one aspect of the rule set, and wherein the applying is further to generate the interpretation of the at least one aspect of the rule set.

16. The method of claim 15, further comprising:
presenting the interpretation of the at least one aspect of the rule set.

17. The method of claim 16, wherein the prompt is obtained from a client system, and wherein the interpretation is presented to the client system.

18. The method of claim 11, wherein the applying is further to generate an interpretation of at least one aspect of the rule set, the method further comprising:
presenting the interpretation of the at least one aspect of the rule set.

19. The method of claim 11, wherein the generative model comprises a large language model-based machine learning model.

20. The method of claim 11, wherein the generative model comprises a generative pre-trained transformer model.
